(19) United States
(12) Patent Application Publication
(10) Pub. No.: US 2022/0400657 A1
(43) Pub. Date: Dec. 22, 2022

(54) AQUACULTURE FEEDING APPARATUS AND METHOD

(71) Applicant: Kent Corporation, Muscatine, IA (US)

(72) Inventor: Joshua Jeffry Humphreys, Muscatine, IA (US)

(21) Appl. No.: 17/837,361

(22) Filed: Jun. 10, 2022

Related U.S. Application Data
(60) Provisional application No. 63/209,876, filed on Jun. 11, 2021.

(51) Int. Cl. A01K 61/85; A23K 50/80

(52) U.S. Cl. CPC A01K 61/85; A23K 50/80

(57) ABSTRACT

Apparatus and methods for aquaculture feeding are provided and, in particular, apparatus and methods for mixing dry feed with water to form a flowable feed composition and distributing the flowable feed composition in a fish or other aquaculture tank at multiple locations in the form of discrete extrudates. The apparatus and methods can be used to adjust properties of the extrudates to correspond to the conditions of fish in the tank and/or conditions in the tank.

### CROSS-REFERENCE TO RELATED APPLICATION

This application claims the benefit of U.S. Appl. No. 63/209,876, filed Jun. 11, 2021, which is hereby incorporated by reference in its entirety.

### FIELD

Apparatus and methods for aquaculture feeding are described herein. In particular, apparatus and methods for distributing a feed composition in a fish or other aquaculture tank are described.

### BACKGROUND

Aquaculture, or the farming of aquatic animals, such as fish, requires the feeding of the aquatic animals. The food is often provided in pre-made pellet form. One method is to simply distribute the pellets across the surface of the water using a spreader. Another method is to distribute the pellets below the surface of the water using floating equipment with a subsurface spreader. Systems such as these often use pre-made pellets, thereby disadvantageously limiting customization of the food. Some prior approaches involve manual spreading of food on the surface of a tank. Such approaches are subject to variance and human error.

### SUMMARY

Apparatus and methods for aquaculture feeding are described herein and, in particular, apparatus and methods for mixing dry feed with water to form a customizable, flowable feed composition and distributing the flowable feed composition in a fish or other aquaculture tank at multiple locations in the form of discrete extrudates. Advantageously, the apparatus and methods can be used to adjust properties of the extrudates to correspond to the conditions of fish in the tank and/or conditions in the tank, as will be described further herein.

Feed compositions for aquatic animals, including vertebrate and invertebrate aquatic animals, are also disclosed herein. The feed compositions may be used for feeding farm-raised tilapia or for feeding shrimp, but it is contemplated that the feed compositions may be used for feeding other fish, shellfish, invertebrates or other animals farmed using aquaculture. The feed compositions are useful for manual spreading, but are deemed particularly useful in the above-described apparatus and methods. It is additionally contemplated that the feed compositions are usable in fresh or salt water, and usable in confined, terrestrial, or open ocean operations. Also disclosed are feed compositions which are extruded to form feed extrudates. Further, methods of preparing a feed composition, methods of preparing a feed extrudate, as well as methods of feeding aquatic animals, are provided.

### BRIEF DESCRIPTION OF THE DRAWINGS

FIG. 1 is a schematic diagram depicting an exemplary embodiment of an apparatus for aquaculture feeding, showing a feed mix container connected relative to a mixing tank, the mixing tank being connected to a plurality of extrusion points positioned above a tank for aquatic animals, and depositing a feed extrudate into the tank;

FIG. 2 is a cut-away view of the mixing tank of FIG. 1, showing an internal stir bar for stirring water and dry feed from the feed mix container to form a flowable feed composition;

FIG. 3 is an enlarged view of a neck of the feed mix container and a dry feed inlet of the mixing tank;

FIG. 4 is a view of an exemplary embodiment of an extrusion head suitable for use with the apparatus of FIG. 1;

FIG. 5 is a view of an exemplary embodiment of a feed extrudate; and

FIG. 6 is a diagrammatic depiction of an exemplary embodiment of input, output and feedback variables for a controller suitable for use with the apparatus of FIG. 1.

### DETAILED DESCRIPTION

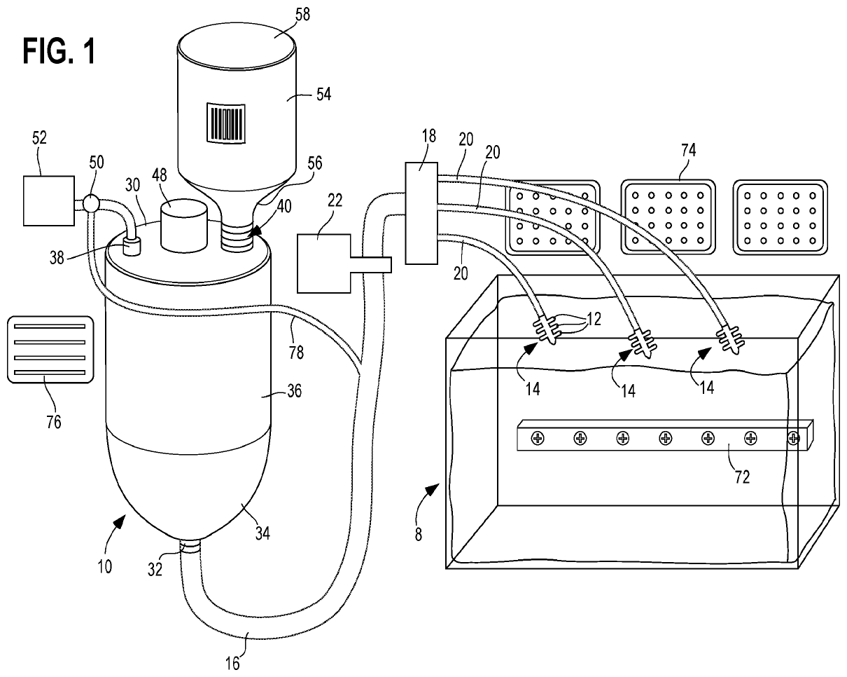

In one exemplary form, the apparatus for aquaculture feeding of fish or other animals in an aquaculture tank 8 includes a mixing tank 10 for supplying a flowable feed composition to multiple extrusion points 12, as shown in FIG. 1. The extrusion points 12 can be part of an extrusion head 14 and multiple extrusion heads 14 can be provided. A main supply line 16 extends between the mixing tank 10 and an optional valve manifold 18. Multiple extension lines 20 each extend from the valve manifold 18 and terminate at an attached one of the extrusion heads 14. A pump 22 is positioned to pump the flowable feed composition through the main supply line 16 and the extension lines 20 and through the extrusion heads 14 and thus the extrusion points 12. The heads and associated piping may have any size appropriate for the particular installation. In some cases, the heads are spaced apart by about 2-6 in, or in some cases 3.5 in, and the piping is sized such that the material linear velocity in the piping prior to release is about 20-60 ft/s, or in some cases 40 ft/s.

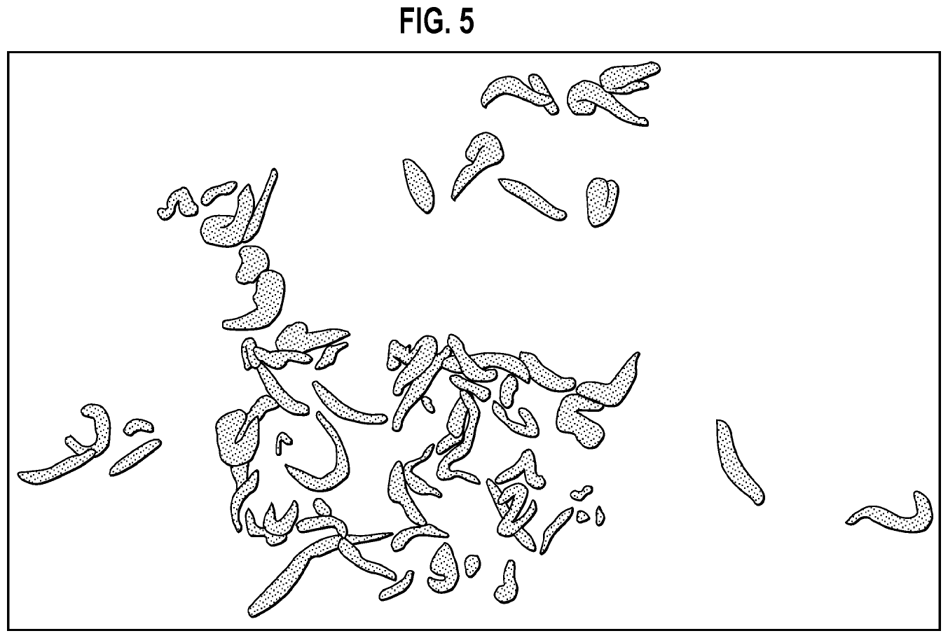

When in operation, the flowable feed composition is extruded through the extrusion points 12 and into water in the aquaculture tank 8. The extrusion points 12 are located above the water level in the aquaculture tank 8 such that the extrudate falls under operation of gravity into the water. Depending upon the consistency of the extrudate and pulsation of the pump 22, discrete extrudates can be extruded from the extrusion points 12 of the extrusion heads 14. The shape of the extrudates can resemble a natural meal worm or other such natural aquatic feed, as shown in FIG. 5. For example, the extrudates can have a bulbous end and a relatively thinner, tapering tail. The thinner, tapering tail can oscillate, making it more attractive for feeding. It is theorized that by more closely resembling a natural meal worm, feeding can be improved. By enhancing the shape of the feed, simulating the natural feed of a given species of aquatic animal, e.g., tilapia, can increase predation, increase nutrient uptake and decrease uneaten feed. Other species may prefer different shapes of feed. For example, non-predatory or bottom feeding fish may prefer a more spheroid or worm-shaped feed. Variations in extrudate shaped can be achieved, for example, by adjusting the flow rate through the extrusion points, the inner diameter of the extrusion points, the fall height from the extrusion points to the water level in the aquaculture tank 8, among other parameters.

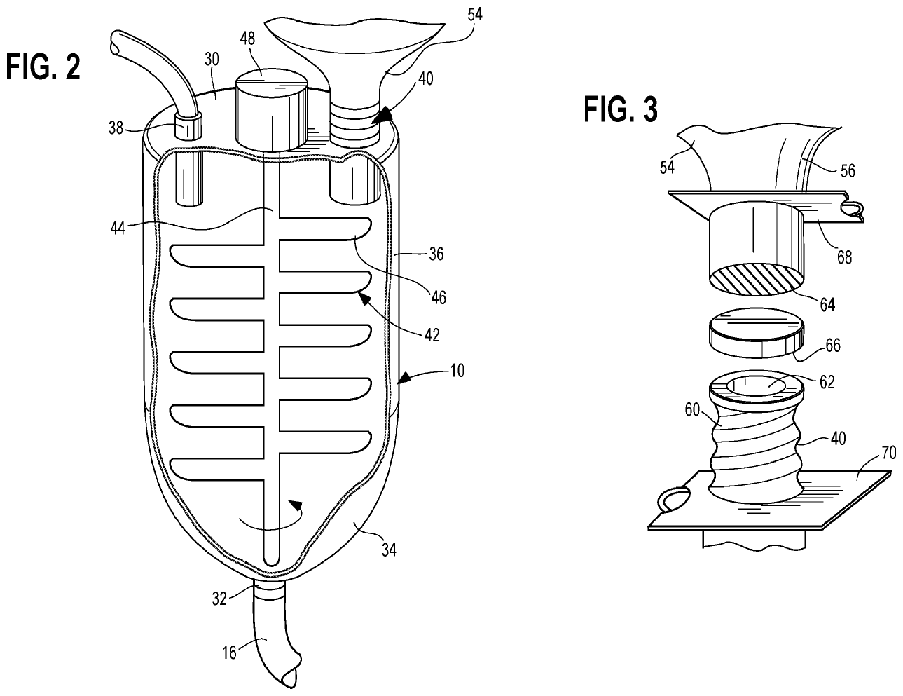

Turning to details of the exemplary mixing tank 10, shown in FIGS. 1-3, the tank has a lid 30 at the top and an outlet 32 at the tapered or generally conical bottom 34, with a sidewall 36 extending therebetween to define an interior of the tank 10. The lid 30 includes a water inlet 38 and a dry feed inlet 40. A stir bar 42 is disposed in the interior of the mixing tank 10, as shown in FIG. 2. The stir bar 42 includes a central shaft 44 with radially-extending paddles 46. An upper end of the central shaft 44 is operatively attached to a mixing tank motor 48. The mixing tank motor 48 is mounted to an exterior of the lid 30. The mixing tank motor 48 drives the central shaft 44 for rotation, thereby also rotating the radially-extending paddles 46.

The water inlet 38 can be connected to a supply of pressurized water 52 via a water valve 50. The supply of pressurized water 52 can be fed via a water pump (actuation of which may function as a water valve). Alternatively, the supply of pressurized water 52 can be via gravity, with the water valve 50 controlling the amount of water passing through the water inlet 38 and into the interior of the mixing tank 10.

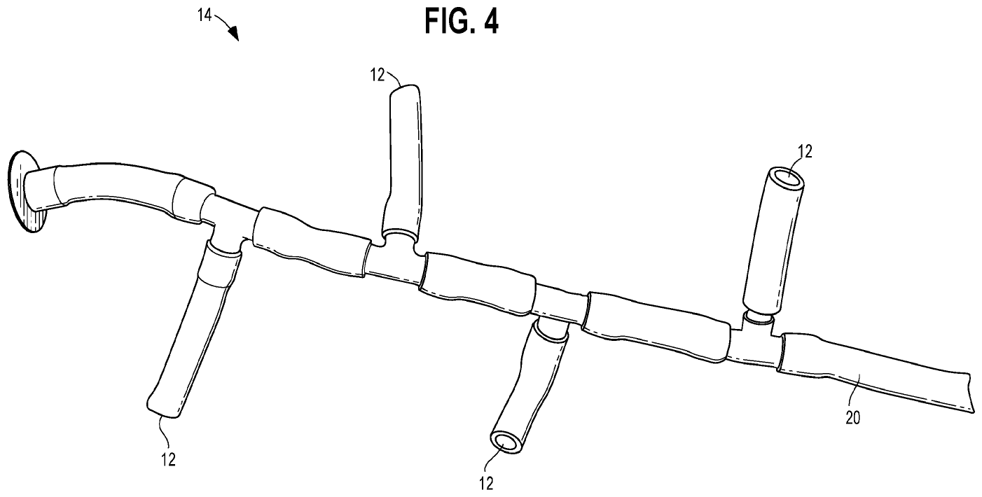

The dry feed can be provided in a dry feed container 54. By “dry” connotes feed that is generally solid in appearance and in a state prior to being mixed with water as described herein. “Dry” feed may itself have a moisture content such that the feed is less than 100% by weight feed on a dry solids basis, or instead the feed may include 100% by weight feed on a dry solids basis. The dry feed container 54 can be generally bottle-shaped, having a neck 56 opposite a closed bottom 58. The dry feed inlet 40 can include an intake port 60 with a through opening 62 protruding from the exterior of the lid 30, as shown in FIG. 3. The intake port 60 seals against an inside of the neck 56 of the dry feed container 54 and allows for the dry feed to pour into the interior of the mixing tank 10 via the opening 62 of the port 60. Sealing with the neck 56 of the dry feed container 54 can be via threading, friction fit or the like. A tamper-evident sealing foil 64 can cover the opening of the neck 56 prior to use. The sealing foil 64 can either be removed prior to use or pierced using the port 60. A removable cap 66 can attach to the neck 56 and cover the sealing foil 64 prior to use. Prior to use, and after the dry feed container 54 is mounted on the port 60, a slide gate 68 associated with the neck 56 of the dry feed container 54 can be selectively actuated to allow the dry feed to flow through the neck 56. Alternatively, or in addition, a slide gate 70 can be associated with the port 60 to selectively actuated to allow flow of dry feed from the dry feed container 54 into the mixing tank 10. One or both of the slide gates 68 and 70 can be electronically actuated. Other types of gate valves could be used to selectively allow flow through the port 60 and/or from the dry feed container 54.

The dry feed container 54 is one option, but not the only option, that can be used for supplying dry feed to the mixing tank 10. One alternative is to have various components of the dry feed mixed on site. For example, different ingredients can be combined in a pre-mixing tank, upstream of the mixing tank 10, where a paddle or other mixer is used to mix the ingredients into the dry feed. The dry feed can then be fed into the mixing tank 10, such as by using gravity, valving and/or other devices for moving the dry materials, e.g., an auger. In another example, different ingredients can be stored in storage tanks and fed to a pre-mixing tank, upstream of the mixing tank 10, such as using augers or other devices for moving the ingredients to the pre-mixing tank. For example, if the dry feed includes guar gum and soy meal, a separate tank can be provided for storing each of those ingredients. Each tank can have an auger or other device for transferring the ingredient from the storage tank to the pre-mixing tank. Optionally, an auger or other transfer device can be used to transfer the dry feed from the pre-mixing tank to the mixing tank 10. Metering equipment can be used for adjusting the relative amounts of ingredients, such as, for example, adjusting auger speeds.

The extrusion heads 14 are disposed at the ends of the extension lines 20. As mentioned above, the extrusion heads 14 are positioned above the water in the aquaculture tank 8. The extrusion heads 14 are also spaced from each other. For example, the extrusion heads 14 can be arranged in a row, as shown in FIG. 1, a grid or other suitable pattern above the water in the aquaculture tank 8. The extrusion heads 14 are also spaced from each other at a distance dependent in part on growth stage and species. For example, for mature tilapia the extrusion heads 14 could be 10-15 apart; for fry the extrusion heads 14 could much closer, e.g., a foot or two. The extrusion heads 14 can each contain multiple extrusion points 12, such as two, three, four, five, six, seven, eight or any other suitable number. In one exemplary embodiment, shown in FIG. 4, the extrusion head 14 comprises five extrusion points 12 each spaced from each other. The extrusion head 14 is formed of tubing, e.g., outside diameters of 3/16 inch, ¼ inch, other increments up to ¾ inch or more, with one of the extrusion points 12 being disposed at the end of a central tubing piece, two smaller pieces of tubing disposed on one side of the central tubing piece and extending laterally therefrom, and another two smaller pieces of tubing disposed on an opposite side of the central tubing piece and also extending laterally therefrom. The openings at the ends of the central tubing piece and the smaller pieces of tubing form the extrusion points 12 that, for a given extrusion head 14, are spaced from each other, e.g., no closer than 1 inch, no closer than 2 inches, perhaps 12 inches or more in some examples. Preferably, the spacing is such that the extrudate from a given extrusion point enters the water at a different location than the extrudate from an adjacent extrusion point.

Reductions in tubing diameter can be used to adjust the flow rate through a given portion of tubing. For example, some of the extrusion heads 14 can have different diameters of upstream tubing than others so that flow rates can be adjusted between extrusion heads 14. Of course, extrusion heads 14 can be omitted such that the extrusion points 12 are fed directly from the manifold 18 or other valving.

The diameter of orifices of the extrusion points 12 can be, for example, 0.07″ to 0.125″, although other diameters can be suitable depending upon system parameters and the desired extrudate shape and size.

Spacing the extrusion points 12 advantageously contributes to a more uniform distribution of extrudate within the aquaculture tank 8. For example, when the aquatic animal is a fish, some of the fish may tend to quickly congregate where food enters the tank 8 during feeding. When the food is introduced in a concentrated area of the tank 8, this can leave other fish with less to eat and, thus, uneven fish feeding. By having a more uniform distribution of extrudate, a more even fish feeding can be achieved.

As mentioned above, the main supply line 16 extends from the outlet 32, which optionally can include a controlled valve, of the mixing tank 10 to the valve manifold 18 and extension lines 20 extend from the valve manifold 18 to the extrusion heads 14. The valve manifold 18 includes multiple individually actuatable valves, with different valves associated with each one of the extension lines 20. By controlling actuation of the valves, control over which extension lines 20 and, thus, which extrusion heads 14, are supplied with the flowable feed composition can be achieved. The use of the valves can allow for control of the timing and locations that the extrudate exiting the extrusion heads 14 enters the aquaculture tank 8. For example, when feeding fish, extrudate can be introduced via a first extrusion head or set of heads, thereby attracting some of the fish to that area of the aquaculture tank. Extrudate can later be introduced via a second extrusion head or set of heads in a different area of the tank, thereby attracting fish who have not yet eaten or have eaten less to that area of the tank to feed. This sequencing can be achieved by selectively controlling the valves of the valve manifold 18 and, thus, the flow of the flowable food composition through the extension lines and to the extrusion heads 14. The valve manifold 18 is optional. One alternative to the valve manifold 18 is to have the extension lines connected to the main supply line without any intervening valves. Another alternative to the valve manifold 18 is to have a ball or pinch valves for the extension lines and/or some or all of the extension heads 14 or points 12, thereby allowing for more specific control of individual extension heads 14 or groups thereof, or of specific points 12.

A cleaning line 78 can extend between the water valve 50 and the main supply line 16 at a location between the tank outlet 32 and the valve manifold 18. The cleaning line 78 can be operable to supply water or other cleaning fluid forward from the valve manifold 18 and through the extrusion heads 14, such as if the valve of the tank outlet 32 is closed and one or more of the valves of the valve manifold 18 are open. The cleaning line 78 can also be operable to supple water or other cleaning fluid in a reverse flow direction, such as if the valve of the tank outlet 32 is open and the valves of the valve manifold 18 are closed.

The pump 22 is positioned to pump the flowable feed composition through the supply line 16, extension lines 20, extrusion heads 14 and ultimately the extrusion points 12. The pump 22 is preferably, but not necessarily, a peristaltic pump. The use of the peristaltic pump beneficially can result in pulsation of the flowable feed composition through the extrusion points 12. As mentioned above, this pulsation can result in formation of discrete extrudate from the extrusion points 12 that more closely resembles a natural food source. A rotary lobe pump can be used instead of a peristaltic pump; of course, other suitable pumps can be used for moving the flowable feed composition, which can depend in part upon the viscosity of the composition and the tubing and extrusion point 12 sizes. A variable frequency drive (VFD) can optionally be used for the pump to adjust flow or pressure based upon demand.

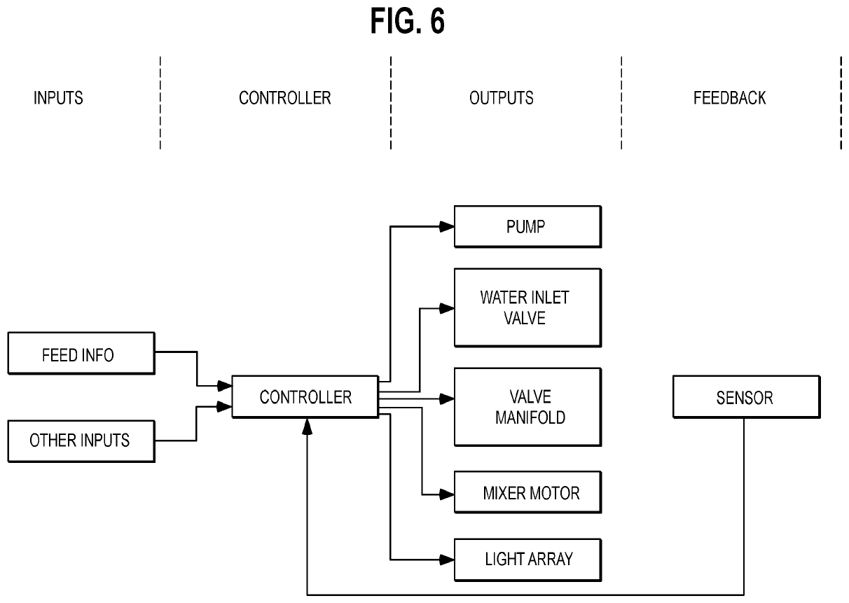

A controller 76, such as a programmable logic controller (PLC), can be configured to control the aquaculture feeding apparatus. The controller 76 can receive input from multiple sources and, based upon those inputs, can control multiple components of the apparatus in order to optimize feeding of the animals raised in the aquaculture tank 8, as is shown in the diagrammatic depiction of FIG. 6.

Sources of feedback can also be used by the controller 76 for controlling components of the apparatus. It is contemplated that the controller can include a remote interface (not shown) for sending and receiving data and command instructions from a remote source. For example, a mobile device application can be used to monitor and control the programmable logic controller from a remote location.

In the exemplary embodiment, the controller 76 can receive an input in the form of information about the dry feed in the dry feed container 54. A bar code or the like on the dry feed container 54, or other code associated with the dry feed, can be scanned to identify the dry feed using the controller 76. Instructions associated with the dry feed can thus be accessed from a memory of the controller 76. For example, one type of dry feed may be for an early growth stage of the animals in the aquaculture tank 8. Instructions associated with the dry feed can include adjustments to components of the apparatus to make a smaller extrudate, for example. Another type of dry feed may be for a later growth stage of the animals, and the associated instructions may be for making a relatively larger extrudate. Other inputs can include information regarding vaccine content, vitamin content, antibiotic content, and/or other nutraceutical content for animal wellness.

In the exemplary embodiment, the controller 76 can output signals to control components of the apparatus. Examples of such components include the pump 22, water valve 50, tank outlet valve 32, each of the valves of the valve manifold 18, the motor 48 of the stir bar 42 of the mixing tank 10, and optional aquaculture LED lights 74. The pump 22 can be operated at different speeds, resulting in different pulsation and different feed rates, which can in turn be used to vary the size of the extrudate. The water valve 50 can be controlled to adjust the amount of water mixed with the dry feed to control the moisture content and density of the flowable feed composition and thus the extrudate. Each of the valves of the valve manifold 18 can be actuated to control the timing and location of the introduction of the extrudate into the aquaculture tank 8, as described above. The motor 48 of the stir bar 42 can be controlled to rotate the stir bar 42 at different speeds to alter, for example, the density and aeration of the flowable food composition and thus the extrudate. For example, a faster rotation speed of the stir bar 42 can introduce more agitation and thus more air into the flowable feed composition. The more air in the flowable feed composition, the lower the density of the extrudate. Adjusting the density of the extrudate can advantageously allow for more control of the sink rate of the extrudate in the water of the aquaculture tank 8. For instance, a denser extrudate can sink to the bottom faster, which can be advantageous for bottom feeding fish. A less dense extrudate can float near the surface, which can be advantageous for other types of fish.

Feedback sources can also provide information to the controller for use in adjusting the outputs. Examples of feedback sources include temperature sensors for sensing the water temperature in the aquaculture tank, turbidity sensors, and broad spectrum gas sensors. For example, a dissolved oxygen sensor can detect changes in oxygen level as different fish require different oxygen levels. Feeding can be paused, e.g., by stopping the pump from operating, while oxygen and/or nitrogen levels are adjusted. The sensors can optionally be in an array 72 in the aquaculture tank 8. The feedback sources can be used as inputs for the controller, which can be programmed to generate an alarm in certain conditions or to automatically adjust a feeding program as may be required.

Turning now to details of the flowable feed compositions, the feed compositions or extrudates described herein have the property of cohesiveness, whereby the particles of the feed composition or extrudate exhibit a tendency of cohering to one another, or whereby the feed composition or extrudate is able to retain a substantial proportion of its weight for a length of time in water without significant disintegration. More specifically, the feed compositions and extrudates are gelatinoid, having gel structure or a gel-like thixotropic property, due to the presence of a cohesiveness agent combined with water. Advantageously, the feed compositions are cohesive at specific ranges of water temperatures for certain amounts of time, so that the feed compositions can have varied application depending on factors such as the type of aquatic animal, the feeding behavior of the animal, and aspects of the environment. Further, the methods of preparing the feed compositions or extrudates are easily adjustable to ensure preferable size and density of the feed, allow the compositions or extrudates to be prepared directly on site, and do not involve the disadvantageous processing with high temperatures and pressures of presently available commercial feed.

Generally, the flowable feed composition comprises a mixture of dry feed ingredients and water, wherein the dry feed ingredients include a gel base comprising a cohesiveness agent and an edible food material. The dry feed ingredients and water, when mixed, produce a cohesive, flowable, gelatinoid feed composition that, as described herein, may be extruded and discharged into an aquatic feed environment, such as an aquaculture tank.

The dry feed ingredients are generally dried and ground into a fine powder. Preferably, the dry feed ingredients remain stable in a mixing tank with water for at least 24 hours.

The base comprises one or more cohesiveness agents, which may be gelling agents, or binders. These may include, for example, guar gum, xanthan gum, dextrose, corn starch, sodium alginate/calcium lactate, agar, gelatin, flax seed, flax seed extract, malt extract, carboxymethyl cellulose, and lecithin, Kappa, Iota, or Lambda carrageenan. A preferred cohesiveness agent is guar gum. For example, the gel base may comprise guar gum, xanthan gum, and cornstarch. In a further embodiment, the gel base may comprise guar gum and dextrose.

In some approaches, the gel base is present in an amount of between 0.1% and 10% by total mass of water used to rehydrate the dry feed ingredients, e.g., 0.75%-2.5%. In some approaches, the gel base is present in an amount effective for the feed composition or extrudate to have a gelatinoid consistency or viscosity. For example, the viscosity may be between 500 cP and up to 12,000 cP, or up to 10,000 cP, or up to 6,000 cP, measured using a Brookfield cone plate viscometer or, if more non-homogeneous, a Brookfield spindle viscometer.

In one example, guar gum is present in the composition in an amount between about 2.5% and 3% by weight. The guar gum in that range can be combined with about 4% by weight soy meal, in one example, along with water, to form the composition.

In some approaches, the gel base, edible food material, and water may be present in the feed composition or extrudate in amounts relative to one another effective for the feed composition or extrudate to retain a specific percentage of its weight for a desired amount of time, at one or more specific ranges of water temperature, after being introduced into the aquatic feed environment. The feed extrudate retaining a percentage of its weight functions to prevent the inefficient feeding that may occur if the feed disintegrates or crumbles in the feed environment too soon. This is particularly advantageous for certain fish that have a physiology of the mouth and throat that makes crumbs or smaller feed more difficult to consume.

For example, in one preferred embodiment, the feed extrudate retains 85% to 90% of its weight after being introduced into the aquatic feed environment for a specified time period and at the intended temperature of the tank. The specified time period may be at least 10 minutes after being introduced into the aquatic feed environment, and preferably at least 15 minutes after being introduced into the aquatic feed environment, or may be at least 20 minutes after being introduced into the aquatic feed environment, or at least 25 minutes after being introduced into the aquatic feed environment.

Many species of aquatic animals are temperature-sensitive and require specific water temperatures to live or thrive. Thus, it is advantageous that the feed compositions or extrudates disclosed herein retain cohesiveness at different temperature ranges. In one embodiment, such as for feeding trout, the feed composition or extrudate retains a specific percentage of its weight in water having a temperature of about 50°-60° F. In other embodiments, such as for feeding tropical fish, the feed composition or extrudate retains a specific percentage of its weight in water having a temperature of about 75′-90° F. For feeding tilapia, the feed composition or extrudate retains a desired percentage of its weight in water having a temperature of about 70°-85° F.

The edible food material of the feed composition generally comprises organic matter from one or more species from the Araceae family, the Lemnoideae subfamily, and the Lemna, Spirodela, Wolffia, Wolffiella genera, including those species with common names such as duckweed, water lentils, water lenses, and bayroot. The edible food material may additionally comprise organic matter from one or more algaes such as Chlamydomonas spp., Spirulina spp., Chlorella spp., Haematococus pluvialis, Nanochlropsis salina, Nannochloropsis oculata, Euglena spp., chrysophyta, Pyrrophyta, and chlorophyte. The edible food material may also include organic matter from one or more of Zea mays, Glycine max, Triticum spp., Hordeum vulgare, Oryza sativa, Oryza glaberrima, and fish meal. Generally, genera of algae useful in the edible food material include Dunaliella; Arthospira; Hematococcus; Chlorella; Nannochlorpsis; Tetraselmis; Phaeodactylum; Skeletonema; Scenedesmus; Isochrysis; Schizochytrium; Crypthecodinim; Pavlova; Saccharomyces; Chlamydomonas; and any other suitable genera. Algal classes useful for the food include Phaeophyta (brown algae); Chlorophyta (green algae, most commonly used class for microalgae in feeds); and Rhodophyta (red algae). Microalgae, such as kelp, may be used. These materials may be used in the food individually or in combination and in any amounts suitable

For example, the edible food material may comprise duckweed. The duckweed may be present in an amount of 20% to 99% by total weight of the dry feed ingredients. The edible food material may, for example, comprise duckweed and Chlamydomonas spp.

Inorganic mineral fractions may also be included in the edible food material in any suitable amount. These may include such ingredients as calcium, iron, phosphorus, zinc, magnesium, potassium, sodium, sulfur, cobalt, chlorine, copper, manganese, molybdenum, iodine, and selenium, and may be added in amounts suitable for providing nutritive benefit to the aquatic animal, e.g., depending upon aquatic animal species, growth stage or other aquatic animal dietary needs.

Advantageously, the feed composition or extrudate may additionally comprise medicinal products, such as vaccines, antibiotics, antifungals, hormones, nutraceuticals, and other additives promoting the health of the aquatic animal. Such medicinal products may be blended with the feed composition in measured amounts depending on the needs of the animal.

The feed composition has a nutritional profile that can be varied depending on the type or types of species for which the feed composition is intended, or depending on the nutritional needs of the species at specific life stages.

In one embodiment suitable for a non-fry (100 g or more) tilapia, the feed composition includes the following ranges of nutrients:

Nutrition Ranges for Feed Composition (per 20 g of feed)

| | |
|---|---|
| Calories | 75 to 110 |
| Total Carbohydrates | 6 to 9 g |
| Dietary Fiber | 6 to 12 g |
| Sugars | 0 to 2 g |
| Protein | 6 to 12 g |
| Calcium | 15 to 300 mg |
| Iron | 5 to 10 mg |
| Potassium | 5 to 20 mg |
| Vitamin A | 400 to 1000 mcg |
| Vitamin E | 0.5 to 3 mg |
| Riboflavin | 0.01 to 1 mg |
| Vitamin B6 | 0.005 to 0.2 mg |
| Folate | 22 to 66 mcg |
| Phosphorous | 50 to 200 mg |
| Magnesium | 25 to 100 mg |
| Zinc | 0.5 to 4 mg |
| Chlorophyll | 0 to 200 mg |
| Sodium | 0 to 200 mg |
| Sulfur | 0 to 100 mg |
| Chlorine | 0 to 200 mg |
| Cobalt | 0 to 50 mg |
| Copper | 0 to 50 mg |
| Manganese | 0 to 25 mg |
| Molybdenum | 0 to 20 mg |
| Iodine | 0 to 100 mg |
| Selenium | 0 to 100 mg |

The feed composition may also include a specific amino acid profile having the following ranges, which could be useful for tilapia or other fish, with the lower end of the range suitable for fry or smaller growth stages:

Amino Acid Ranges in Feed Composition (mg per 20 g feed)

| | |
|---|---|
| Alanine | 500 to 2000 |
| Arginine | 500 to 2500 |
| Aspartic acid | 1000 to 3000 |
| Cysteine | 200 to 1000 |
| Glutamic Acid | 1000 to 3000 |
| Glycine | 500 to 1000 |
| Histidine | 100 to 800 |
| Isoleucine | 300 to 1200 |
| Leucine | 1000 to 3000 |
| Lysine | 400 to 1600 |
| Methionine | 200 to 800 |
| Phenylalanine | 1200 to 3100 |
| Proline | 300 to 900 |
| Serine | 400 to 1200 |
| Threonine | 300 to 1900 |
| Tryptophan | 300 to 900 |
| Tyrosine | 300 to 900 |
| Valine | to 400 |

Methods of preparing the feed composition described herein may generally comprise providing dry feed ingredients comprising an edible food material and a gel base, wherein the gel base comprises at least one cohesiveness agent, adding the dry feed ingredients and water to a mixing tank to form a mixture, and agitating the mixture of dry feed ingredients and water to form a gelatinoid feed composition, wherein the gelatinoid feed composition is flowable as the flowable feed composition.

The dry feed ingredients, which can also include any gum agents, can be added slowly to the water in the mixing tank, with continuous mixing occurring while the dry feed ingredients are added. The dry feed ingredients can be premixed, such as in a feed conditioning tank using a such as in a paddle mixer or ribbon blender, upstream of the mixing tank. Optionally, a high shear mixer can be provided upstream of the pump to facilitate reduction of lumps in the flowable feed composition.

Further, methods of preparing a flowable feed composition, and extrudate therefrom, may comprise providing dry feed ingredients comprising an edible food material and a gel base, wherein the gel base comprises at least one cohesiveness agent, adding the dry feed ingredients and water to a mixing tank to form a mixture, agitating the mixture of dry feed ingredients and water to form a gelatinoid feed composition, wherein the gelatinoid feed composition is flowable, pumping the gelatinoid, flowable feed composition from the main supply tubing, described above, into the multiple extension tubes terminating in extrusion heads each with multiple extrusion points, and extruding the gelatinoid feed composition to produce discrete extrudates.

Also contemplated are methods of feeding aquatic animals, generally comprising providing dry feed ingredients comprising an edible food material and a gel base, wherein the gel base comprises at least one cohesiveness agent, adding the dry feed ingredients and water to a mixing tank to form a mixture, agitating the mixture of dry feed ingredients and water to form a gelatinoid feed composition, wherein the gelatinoid feed composition is flowable, pumping the gelatinoid, flowable feed composition from the main supply tubing, described above, into the multiple extension tubes terminating in extrusion heads each with multiple extrusion points, and extruding the gelatinoid feed composition to produce discrete extrudates, wherein the extrudates are deposited directly into the aquaculture tank to be consumed by aquatic animals.

In the above-described methods, the mixture of dry feed ingredients and water may be agitated for any suitable period of time, such as at least two minutes, to form the gelatinoid feed composition. The temperature of the water added to the mixing tank may be any suitable temperature, such as a range from about 50° to about 65° F. The water and dry feed ingredients may be added to the mixing tank in any suitable ratio, for example, 20:1 to 10:1.

Generally, in the above-described methods the length of time and/or the speed of agitating the mixture of dry feed ingredients and water can be varied to adjust the density of the extrudate. Adjusting the density of the extrudate allows for control over whether the extrudate tends to float, sink, or be present in specific tiers or depths of the water, as mentioned above. Since some aquatic animals have preferences for top-floating feed or for sinking feed, or, alternatively, benefit when feed is present at specific depths or tiers of the water, being able to control the floating properties of the feed extrudate is advantageous. Generally, the longer or more vigorously the mixture is agitated, the more air will be whipped into the feed composition, causing the extrudate to have a lower density and tend toward floating. Conversely, the less the mixture is agitated, the less air will be whipped into the feed composition, causing the extrudate to have a higher density and tend toward sinking. It is contemplated that in some embodiments, different tiers of feed having different densities may be added at various times in order to feed different strata of fish or other animals.

The density of the extrudate may further be adjusted by varying the speed of pumping the gelatinoid feed composition from the main supply tubing into the multiple extension tubes. Generally, a faster pump speed will tend to further compress the extrudate and cause release of air, resulting in feed with a higher density, while a slower pump speed will have the opposite effect.

The size of the extrudate may also be adjusted through a variety of factors. Factors that affect the size of the extrudate which may be adjusted to prepare a suitable feed extrudate include pump speed, the diameter of the extrusion head orifices, the viscosity of the feed composition and/or amount of the gel base, and the length and speed of agitating the mixture of dry feed ingredients and water in the mixing tank.

The feed composition may be extruded for delivery to the aquatic animal over any suitable period of time, such as at least one hour, at least 12 hours, or at least 24 hours. The extrudates may be discharged directly into an aquaculture tank or other confined area. It is also contemplated that the feed extrudates may be discharged into a natural aquatic environment, such as an open ocean. Generally, the feed extrudates may be discharged into any suitable aquatic environment.

In one non-limiting example, dry feed ingredients comprising 0.5% guar gum by weight, 0.25% xanthan gum by weight, 0.25% cornstarch by weight, 50% Clamydomonas spp. by weight, and 49% duckweed by weight are added to water at a temperature of 60° F. to form a mixture. The mixture is mixed vigorously for two minutes, after which the mixture is let sit for at least two minutes. A flowable, gelatinoid feed composition is formed.

In another non-limiting example, dry feed ingredients comprising 1.5% guar gum by weight and up to 99% duckweed by weight of the dry mixture are added to water at a temperature of 60° F. to form a mixture. The mixture is mixed vigorously for two minutes, for example. A flowable, gelatinoid feed composition is formed.

In an additional non-limiting example, dry feed ingredients comprising 1.5% guar gum by weight, 0.5% dextrose by weight, 75% Clamydomonas spp. by weight, and 23% duckweed by weight of the dry mixture are added to water at a temperature of 60° F. to form a mixture. The mixture is mixed vigorously for two minutes. A flowable, gelatinoid feed composition is formed.

In yet another non-limiting example, the cohesive feed composition comprises about 757 L of water, about 7.5 kg of guar gum, and about 37.9 kg of duckweed. In other words, a ratio of about 1:5 for guar gum: duckweed and about 20:1 water: dry ingredients could be used, for example.

The illustrated embodiment envisions a fixed installation, but it is contemplated that mobile installations of an aquaculture feeding apparatus and system may be provided. A mobile installation may include some or all of the components described herein, as appropriate, in some form of mobile system such as the bed of a truck.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms.

Any description of certain embodiments as “preferred” embodiments, and other recitation of embodiments, features, or ranges as being preferred, or suggestion that such are preferred, is not deemed to be limiting. The invention is deemed to encompass embodiments that are presently deemed to be less preferred and that may be described herein as such. All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

1. An apparatus for supplying discrete extrudates to an aquaculture tank, the apparatus comprising:
a mixing tank for mixing dry feed and water to form a flowable feed composition;
a plurality of extrusion points for extruding the flowable feed composition in discrete extrudates;
one or more supply lines for supplying the flowable feed composition from the mixing tank to the plurality of extrusion points; and
a pump for forcing the flowable feed composition through the supply lines and to the plurality of extrusion points.

2. The apparatus of claim 1, further comprising a plurality of spaced extrusion heads, wherein each extrusion head includes multiple ones of the plurality of extrusion points.

3. The apparatus of claim 2, wherein the one or more supply lines comprise:
a main line between the mixing tank and a valve manifold; and
extension lines each extending between the valve manifold and one of the extrusion heads.

4. The apparatus of claim 3 further comprising a controller for controlling the valve manifold to selectively control flow through the extension lines for determining supply of the flowable feed composition to the plurality of spaced extrusion heads.

5. The apparatus of claim 1, wherein the mixing tank comprises:
an inlet for dry feed;
an inlet for water;
an outlet connected relative to the one or more supply lines;
a stir bar for mixing dry feed and water within the mixing tank to form the flowable feed composition; and
a mixing tank motor for rotating the stir bar.

6. The apparatus of claim 5, further comprising a controller for controlling the pump and the mixing tank motor for adjusting the density of the extrudates.

7. The apparatus of claim 6, wherein the one or more supply lines comprise: a main line between the mixing tank and a valve manifold; and extension lines each extending between the valve manifold and one of the extrusion heads; and wherein the controller selectively controls the valve manifold to control flow through the extension lines for determining supply of the flowable feed composition to the plurality of spaced extrusion heads.

8. The apparatus of claim 5 in combination with an aquaculture tank.

9. The apparatus of claim 8, wherein the aquaculture tank contains water, and wherein each of the plurality of extrusion points are disposed above the water in the aquaculture tank for depositing the extrudates directly into the water.

10. The apparatus of claim 9, further comprising sensor means for sensing one or more parameters associated with the aquaculture tank, the sensor means being operatively connected to the controller for providing feedback for use in controlling the pump and the mixing tank motor.

11. A method of supplying discrete extrudates to the aquaculture tank using the apparatus of claim 9, comprising:
mixing dry feed and water in the mixing tank to form a flowable feed composition;
pumping the flowable feed composition from the mixing tank to the plurality of extrusion points via the one or more supply lines; and
extruding the flowable feed composition through the plurality of extrusion points as the discrete extrudates and directly into the water of the aquaculture tank.

12. The method of claim 11, wherein the dry feed comprises an edible food material and a cohesiveness agent, wherein the cohesiveness agent is present in an amount of from 0.1% to 10% by total weight of the dry feed.

13. The method of claim 12, wherein the flowable feed composition is gelatinoid.

14. The method of claim 11, further comprising adjusting the density of the discrete extrudates.

15. A method of supplying discrete extrudates to an aquaculture tank containing water, the method comprising:
mixing dry feed and water to form a flowable feed composition;
extruding discrete extrudates from the flowable feed composition directly into water of the aquaculture tank at a plurality of spaced locations; and
adjusting the density of the extrudates depending upon aquaculture tank conditions.

16. The method of claim 15, wherein aquaculture tank conditions include one or more of: growth stage of aquatic animals in the aquaculture tank; and type of aquatic animals in the aquaculture tank.

17. The method of claim 15, wherein the step of extruding discrete extrudates directly into water of the aquaculture tank at a plurality of spaced locations includes extruding the discrete extrudates through a plurality of extrusion points positioned above the water of the aquaculture tank.

18. A feed composition comprising a mixture of dry feed ingredients and water, wherein the dry feed ingredients comprise an edible food material and a gel base, the gel base comprising at least one cohesiveness agent, wherein the at least one cohesiveness agent is guar gum and is present in an amount of from 0.1% to 10% by total weight of the dry feed ingredients.

19. The feed composition of claim 18, wherein the food material comprises duckweed in an amount of 20% to 99% by total weight of the dry feed ingredients.

20. The feed composition of claim 12, wherein the edible food material comprises Chlamydomonas spp.
